(19) United States
(12) Patent Application Publication
(10) Pub. No.: US 2024/0378673 A1
(43) Pub. Date: Nov. 14, 2024

(54) AUTOMATIC INVESTMENT PLATFORM SERVICE PROVIDING SYSTEM AND METHOD BY ROBO-TRADING BASED ON AI

(71) Applicant: MOFIN CO., LTD., Seoul (KR)

(72) Inventor: Joon Mo KIM, Seoul (KR)

(73) Assignee: MOFIN CO., LTD., Seoul (KR)

(21) Appl. No.: 18/517,573

(22) Filed: Nov. 22, 2023

(30) Foreign Application Priority Data
May 9, 2023 (KR) 10-2023-0059668
May 15, 2023 (KR) 10-2023-0062284
May 15, 2023 (KR) 10-2023-0062285

(51) Int. Cl. G06Q 40/06; G06Q 40/04

(52) U.S. Cl. CPC G06Q 40/06; G06Q 40/04

(57) ABSTRACT

The present disclosure relates to an automatic investment platform service providing system that improves the convenience and profitability of stock trading through robo-trading, and a method thereof.

### CROSS-REFERENCE TO RELATED APPLICATION

This application claims the benefit under 35 USC § 119(a) of Korean Patent Application Nos. 10-2023-0059668 filed on May 9, 2023, 10-2023-0062284 filed on May 15, 2023, and 10-2023-0062285 filed on May 15, 2023, the entire content of which are incorporated herein by reference.

### TECHNICAL FIELD

The present disclosure relates to an automatic investment platform service providing system and a method thereof. In particular, the present disclosure relates to an automatic investment platform service providing system that improves the convenience and profit stability of stock trading through robo-trading, and a method thereof.

### BACKGROUND ART

In the case of conventional stock investment, individual investors have performed transactions using home trading systems (HTS), mobile trading systems (MTS), and the like.

In this case, investors must perform numerous studies and analyses in constructing a portfolio that suits their preferences, and must refer to more market information analysis and financial investment-related news and expert information in order to achieve stable and sustainable profits.

Furthermore, there are many cases where investors make investments without asking questions using indiscriminately overflowing investment information and rumors on social network services (SNS). In addition, in the case of investing in overseas stocks, time lag problems may occur because investments must be made at a time that matches the stock market of the country.

To solve these problems, in recent years, the use of a robo-advisor using artificial intelligence and algorithms has been increased.

In the case of the robo-advisor, it may provide lower fees and higher rates of returns to customers through quickly and accurately analyzing customers' investment tendencies and applying an algorithm to construct an optimal portfolio.

However, in the case of an existing robo-advisor, it is difficult to respond to issues that occur in real time because the robo-advisor performs an algorithm based only on past data when making investment decisions.

In addition, in the case of an existing robo-advisor, most investments were made through an asset distribution method that adjusted the proportions of stocks, bonds, and cash. In the case of an existing robo-advisor, it was difficult to immediately respond to market volatility situations due to being operated by inputting a quote data delayed price or a previous day's closing price as a price used as a reference.

Furthermore, in the case of an existing robo-advisor, investments were ultimately executed with human intervention such as trading being carried out directly by an investor or by a fund manager on his or her behalf when portfolio composition strategies or items are recommended and delivered to the investor.

Therefore, there is a problem in that it is difficult to quickly establish an investment strategy that reflects an immediate response or trend in the case of a customer's investment propensity or a suddenly occurring problem (such as a sudden rise or fall in a specific stock).

As described above, in the case of conventional technologies, even when an investment is made through a robo-advisor, the reality is that it is operated in a structure where essential management personnel are deployed and when problems arise, the people directly resolve the problems.

Besides, Korean Patent Publication No. 10-2017-0014397 (published on Feb. 8, 2017) discloses a real-time automatic stock trading method for open API and a computer program for executing the same, but even in the case of the invention, rather than performing a transaction that excludes human emotions, an actual person sets a conditional search formula to check the searched items according to the conditions and perform the transaction, and thus there is a problem in that the return on investment may differ significantly depending on what condition search formula the person sets.

### CITATION LIST

### Patent Literature

(Patent Document 1) Korean Patent Publication No. 10-2017-0014397 (published on Feb. 8, 2017)

### DISCLOSURE OF INVENTION

### Technical Problem

The present disclosure is contrived to solve the foregoing problems, and an aspect of the present disclosure is to provide an automatic investment platform service providing system capable of immediately reflecting market volatility due to receiving and operating real-time price data, allowing stable stock investment through robo-trading, even though, with a low understanding of stock trading, particularly maintaining a stable rate of investment return (stable mid-range rate of return compared to an index), recommending stocks suitable for a current market situation to an individual even when he or she does not study and analyze individual stocks for himself or herself, calculating appropriate prices for individual items to automatically perform transactions at the appropriate prices, and performing rebalancing in real time according to an investment result that occurs subsequent to the performed transactions, and a method thereof.

Technical problems of the present disclosure are not limited to the above-mentioned problems, and other technical problems which are not mentioned herein will be clearly understood by those skilled in the art from the description below.

### Technical Solution

In order to achieve the foregoing objectives, according to the present disclosure there is provided an automatic investment platform service providing system, including a storage unit that stores an investor's asset information, a communication unit that receives real-time price information for each item from an external server, and an analysis unit that analyzes the real-time price information for each item, wherein the analysis unit calculates an appropriate price for each individual item using an analysis result of the real-time price information for each item, and establishes a first investment strategy based on the calculated appropriate price, and the communication unit transmits the first investment strategy to a transaction server, and the first investment strategy includes a trading order that reflects an appropriate price for each individual item.

The analysis unit may compute a relative strength based on structured data and unstructured data, including an analysis result of the real-time price information for each item, and calculate an appropriate price for the individual item using the computed relative strength.

The structured data may further include a market adjustment ratio calculated through artificial intelligence learning based on market data including at least two market indicator data, and an item adjustment ratio calculated through artificial intelligence learning based on individual item data, including spot and/or futures price data of each individual item.

The unstructured data may include at least one of news information, institutional information, and expert information.

The foregoing investment strategy, as a core investment strategy, uses price data for generating ratios and indicators including a market adjustment ratio and an item adjustment ratio, structured data including fundamental data or the like of companies corresponding to items subject to trading, and unstructured data including news information, institutional information, expert information, and the like. Furthermore, the foregoing investment strategy is an investment strategy based on an automatic investment method of constructing an automatic portfolio based on a quantitative analysis through an artificial intelligence (AI) model by receiving and utilizing real-time quote data for stock items in the country through an API, and then computing a relative strength on an overall market situation and a stock price flow for each item in the country using a specific artificial intelligence (AI) quant formula, and sending, by the AI, a trading order signal directly to a securities company account linked thereto through the communication unit to conclude a trade.

The communication unit may receive the investor's investment propensity, and the storage unit may store the investor's investment propensity received by the communication unit, and the analysis unit may establish a second investment strategy that reflects the investor's investment propensity, and the communication unit may transmit the second investment strategy to the transaction server, and the second investment strategy may include a trading order that reflects an appropriate price of an item set to reflect the investor's investment propensity.

The storage unit may store a proportion of the investor's asset, and the communication unit may receive a transaction execution result according to a trading order from an external server, and when a proportion of the investor's asset changes based on the transaction execution result according to the trading order, the analysis unit may establish a follow-up trading strategy so that the changed proportion of the investor's asset corresponds to that of a preset reference asset, and the communication unit may transmit the follow-up trading strategy to the transaction server, and the follow-up trading strategy may include a trading order for an item that makes the changed proportion of the investor's asset match that of the preset reference asset.

The storage unit may store at least one of market indicators for each market, index information, information for each item, performance information for each product, news information, and expert information, and the analysis unit may analyze at least one of market indicators for each market, index information, information for each item, performance information for each product, news information, and expert information to select a recommended theme, and the communication unit may transmit the recommended theme selected by the analysis unit to a user terminal.

The storage unit may store chart information for each specific type, and the analysis unit may calculate a predicted stock price for each item using the chart information for each specific type, and establish a third investment strategy that reflects the predicted stock price for each item, and the communication unit may transmit the third investment strategy to the transaction server, and the third investment strategy may include a trading order that reflects an predicted stock price for each item.

In addition, in order to achieve the foregoing objectives, there is provided an automatic investment platform service providing method, including storing, by a storage unit, an investor's asset information; receiving, by a communication unit, real-time price information for each item from an external server; and analyzing, by an analysis unit, the real-time price information for each item, wherein the analyzing of, by the analysis unit, the real-time price information for each item includes calculating, by the analysis unit, an appropriate price for each individual item using an analysis result of the real-time price information for each item; establishing, by the analysis unit, a first investment strategy based on the calculated appropriate price; and transmitting, by the communication unit, the first investment strategy to a transaction server, and the first investment strategy includes a trading order that reflects an appropriate price for each individual item.

The analyzing of, by the analysis unit, the real-time price information for each item may include receiving, by the communication unit, the investor's investment propensity; storing, by the storage unit, the investor's investment propensity received by the communication unit; establishing, by the analysis unit, a second investment strategy that reflects the investor's investment propensity; and transmitting, by the communication unit, the second investment strategy to the transaction server, wherein the second investment strategy includes a trading order that reflects an appropriate price of an item set to reflect the investor's investment propensity.

The analyzing of, by the analysis unit, the real-time price information for each item may include storing, by the storage unit, a proportion of the investor's asset; receiving, by the communication unit, a transaction execution result according to a trading order from an external server; establishing, by the analysis unit, when a proportion of the investor's asset changes based on the transaction execution result according to the trading order, a follow-up trading strategy so that the changed proportion of the investor's asset corresponds to that of a preset reference asset, and transmitting, by the communication unit, the follow-up trading strategy to the trading server, wherein the follow-up trading strategy includes a trading order for an item that makes the changed proportion of the investor's asset match that of the preset reference asset.

The analyzing of, by the analysis unit, the real-time price information for each item may include storing, by the storage unit, at least one of market indicators for each market, index information, information for each item, performance information for each product, news information, and expert information; analyzing, by the analysis unit, at least one of market indicators for each market, index information, information for each item, performance information for each product, news information, and expert information to select a recommended theme; and transmitting, by the communication unit, the recommended theme selected by the analysis unit to a user terminal.

The analyzing of, by the analysis unit, the real-time price information for each item may include storing, by the storage unit, chart information for each specific type; calculating, by the analysis unit, a predicted stock price for each item using the chart information for each specific type; establishing, by the analysis unit, a third investment strategy that reflects the predicted stock price for each item; and transmitting, by the communication unit, the third investment strategy to the transaction server, wherein the third investment strategy includes a trading order that reflects an predicted stock price for each item.

### Advantageous Effects

According to the present disclosure as described above, there is an effect capable of allowing stable stock investment through robo-trading, even though, with a low understanding of stock trading, particularly maintaining a stable rate of investment return (stable mid-range rate of return compared to an index), recommending stocks suitable for a current market situation to an individual even when he or she not study individual stocks for himself or herself, calculating appropriate prices for individual items to perform transactions at the appropriate prices, and performing rebalancing in real time according to an investment result that occurs subsequent to the performed transactions.

For reference, according to the present disclosure, based on a Sharpe ratio, which is an indicator for evaluating the stability of a rate of investment return, it may have a Sharpe ratio of about 1.8 to 2.3, which means that an investment strategy according to the present disclosure may continuously maintain a certain level of rate of return (the Sharpe ratio is an excess rate of return compared to investment in risky assets, so the higher the indicator, the more stable the performance, but fluctuations are expected depending on market indicators).

The effects of the present disclosure are not limited to those mentioned above, and may be clearly understood by those skilled in the art from the description throughout the specification, but also include other effects that are not explicitly mentioned.

### BRIEF DESCRIPTION OF THE DRAWINGS

FIG. 1 is a diagram showing a schematic configuration of an automatic investment platform service providing system, which is an embodiment of the present disclosure.

FIG. 2 is a diagram showing a schematic flow of a method of providing an automatic investment platform service, which is an embodiment of the present disclosure.

FIG. 3 is a diagram showing a schematic flow of a method of providing an automatic investment platform service, which is another embodiment of the present disclosure.

### DESCRIPTION OF SYMBOLS

10: External server
20: Transaction server
30: User terminal
100: Automatic investment platform service providing system
110: Storage unit
120: Communication unit
130: Analysis unit
140: Fee management unit

### BEST MODE FOR CARRYING OUT THE INVENTION

Hereinafter, preferred embodiments of the present disclosure will be described in detail with reference to the accompanying drawings. Advantages and features of the present disclosure, and methods of accomplishing the same will be clearly understood with reference to the following embodiments described in detail in conjunction with the accompanying drawings. However, the present disclosure is not limited to those embodiments disclosed below but may be implemented in various different forms. It should be noted that the present embodiments are merely provided to make a full disclosure of the invention and also to allow those skilled in the art to know the full range of the invention, and therefore, the present disclosure is to be defined only by the scope of the appended claims. Further, like reference numerals refer to like or similar elements throughout the specification.

Unless otherwise defined, all terms (including technical and scientific terms) used in this specification may be used with meanings that can be commonly understood by those skilled in the art to which the present disclosure pertains. Additionally, terms defined in commonly used dictionaries are not interpreted ideally or excessively unless clearly specifically defined. It should be noted that the terms used herein are merely used to describe the embodiments, but not to limit the present disclosure. In this specification, unless clearly used otherwise, expressions in a singular form include a plural form.

The term “comprises” and/or “comprising” used in the specification intend to express a constituent element, a step, an operation and/or a device does not exclude the existence or addition of one or more other constituent elements, steps, operations and/or devices.

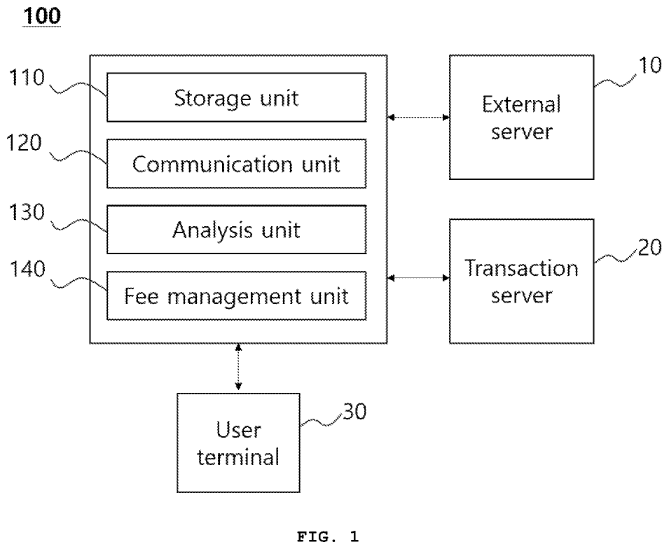

FIG. 1 is a diagram showing a schematic configuration of an automatic investment platform service providing system, which is an embodiment of the present disclosure.

Referring to FIG. 1, the automatic investment platform service providing system 100 may include a storage unit 110, a communication unit 120, an analysis unit 130, and a fee management unit 140.

Furthermore, throughout the specification, data transmission and reception among the communication unit 120, an external server 10, a transaction server 20, and a user terminal 30 is not limited to a specific communication method, and the user terminal 30 may be implemented as a device that can be carried by a user to transmit data through wired or wireless communication, such as a mobile phone, a smartphone, a smart pad, a tablet PC, a laptop, or the like, and may also be implemented as a PC other than the tablet PC. For reference, in this detailed description, the transaction server 20 refers to a server that performs actual transactions according to an investment strategy, and for example, the transaction server 20 may be a server operated by a securities company. In this case, it will be understood that the purpose of a trading order transmitted to the transaction server 20 is to deliver a trading order (trading signal) directly to an API-linked account linked to the securities company. Considering that the present disclosure allows trading to be carried out completely automatically without human intervention, it is to be understood that the trading order is transmitted from the automatic investment and trading platform service providing system 100 to the transaction server 20 to enable trading to be carried out automatically.

More specifically, the storage unit 110 may store an investor's asset information.

Here, the investor's asset information refers to various types of assets such as cash, stocks, bonds, and cryptocurrency held by the investor, and will not be limited to specific assets.

Furthermore, the storage unit 110 may store one or more trading patterns.

Here, one or more trading patterns, which are techniques for stock trading, may include trading techniques that perform stock trading by expecting a rise or fall depending on the shape of a graph, such as triple top, triple bottom, double top, double bottom, rounding top, rounding bottom, V-shaped top, V-shaped bottom, descending triangle, ascending triangle, descending box, ascending box, symmetric triangle, and broadening triangle.

In addition, the communication unit 120 may receive real-time price information for each item from the external server 10.

Here, the external server 10 may refer to a server such as an exchange that holds price information for the corresponding item.

Furthermore, the real-time price information for each item may include at least one of a transaction execution price, a sell offer price, and a buy offer price for a specific item.

More specifically, in the real-time price information for each item, real-time may denote a time within 0.01 to 0.1 seconds after the transaction is concluded in the case of a transaction execution price for a specific item.

Furthermore, in the case of the real-time price information for each item, real-time may denote a time within 0.01 to 0.1 seconds after the sell offer in the case of the sell offer price.

In addition, in the real-time price information for each item, real-time may denote within 0.01 to 0.1 seconds after the buy offer in the case of the buy offer price.

Additionally, the communication unit 120 may receive the investor's investment propensity from the user terminal 30.

Here, the investor's investment propensity may be divided into aggressive investment type, active investment type, risk neutral type, stability seeking type, and stability type.

Furthermore, the analysis unit 130 may analyze real-time price information for each item.

Here, the real-time price information for each item may include not only price information for domestic stocks but also price information for foreign stocks.

More specifically, the analysis unit 130 may calculate an appropriate price for each individual item using an analysis result of the real-time price information for each item, and establish a first investment strategy based on the calculated appropriate price.

When analyzing the real-time price information for each item, the analysis unit 130 may use at least one or a combination of two or more of market indicators for each market, index information, information for each item, performance information for each product, news information, and expert information.

Here, the market indicators for each market, the index information, the information for each item, the performance information for each product, the news information, and the expert information may include information on overseas markets as well as information on the domestic market.

More specifically, the analysis unit 130 may convert at least one of news information and expert information, which are unstructured data, into structured data through performing buzz analysis.

The analysis unit 130 may extract text included in at least one of news information and expert information, which are unstructured data.

Furthermore, the analysis unit 130 may perform opinion mining on the extracted text.

Additionally, the analysis unit 130 may reflect the opinion mining result and assign a numerical score to at least one of news information and expert information, which are unstructured data.

In addition, the analysis unit 130 may perform sentiment analysis on at least one of news information and expert information, which are unstructured data, and the analysis unit 130 may convert at least one of news information and expert information, which are unstructured data, into structured data through sentiment analysis.

Additionally, the analysis unit 130 may perform at least one of buzz analysis and sentiment analysis using machine learning.

Furthermore, the analysis unit 130 may calculate an appropriate price for each individual item using at least one of market indicators for each market, index information, information for each item, performance information for each product, and news and expert information converted into structured data.

In addition, the analysis unit 130 selects a recommended theme for investors to invest in using at least one of market indicators for each market, index information, information for each item, performance information for each product, and news information and expert information converted into structured data.

Furthermore, the analysis unit 130 may construct an investment portfolio corresponding to the investor's investment propensity using at least one of market indicators for each market, index information, information for each item, performance information for each product, and news information and expert information converted into structured data.

In addition, when currently investing in stocks of a specific item using at least one of market indicators for each market, index information, information for each item, performance information for each product, and news information and expert information converted into structured data, the analysis unit 130 may calculate an expected rate of return that can occur after a certain period of time.

Furthermore, when currently investing in stocks of a specific item calculated by the analysis unit 130, the communication unit 120 may transmit the expected rate of return that may occur after a certain period of time to the user terminal 30.

Here, the first investment strategy may include a trading order that reflects an appropriate price for each individual item.

Furthermore, the communication unit 120 may transmit the first investment strategy to the transaction server 20.

Additionally, the analysis unit 130 may select a trading pattern corresponding to the investor's investment propensity. That is, the analysis unit 130 may select a trading pattern corresponding to the investor's investment propensity from one or more trading patterns stored in the storage unit 110.

Furthermore, the communication unit 120 may transmit the trading pattern selected by the analysis unit 130 to the transaction server 20.

Additionally, the communication unit 120 may receive the investor's investment propensity from the user terminal 30.

Furthermore, the storage unit 110 may store the investor's investment propensity received by the communication unit 120.

Additionally, the analysis unit 130 may establish a second investment strategy that reflects the investor's investment propensity.

Here, the second investment strategy may include a trading order that reflects an appropriate price of an item set to reflect the investor's investment propensity.

Furthermore, the communication unit 120 may transmit the established second investment strategy to the transaction server 20.

Additionally, the storage unit 110 may store a proportion of the investor's asset.

Furthermore, the communication unit 120 may receive a transaction execution result according to the trading order from the external server 10.

Here, the trading order may denote a trading order included in at least one of a first investment strategy, a second investment strategy, a third investment strategy, and a follow-up trading strategy, and may also denote a general trading order other than the trading order included in at least one of the first investment strategy, the second investment strategy, the third investment strategy and the follow-up trading strategy, and the trading order will not be limited to a specific trading order.

Furthermore, when a proportion of the investor's asset changes based on the transaction execution result according to the trading order, the analysis unit 130 may establish a follow-up trading strategy so that the changed proportion of the investor's asset corresponds to that of a preset reference asset.

Additionally, the communication unit 120 may transmit a follow-up trading strategy to the trading server 20.

Furthermore, the follow-up trading strategy may include a trading order for an item that makes the changed proportion of the investor's asset match that of the preset reference asset.

In addition, the storage unit 110 may store at least one of market indicators for each market, index information, information for each item, performance information for each product, news information, and expert information.

Furthermore, the analysis unit 130 may analyze at least one of market indicators for each market, index information, information for each item, performance information for each product, news information, and expert information to select a recommended theme.

Additionally, the communication unit 120 may transmit the recommended theme selected by the analysis unit 130 to the user terminal 30.

Furthermore, the analysis unit 130 may construct an investment portfolio corresponding to the investor's investment propensity using at least one of real-time price information for each item received by the communication unit 120 from the external server 10, and market indicators for each market, index information, information for each item, performance information for each product, news information, and expert information stored by the storage unit 110.

In addition, the analysis unit 130 may generate a trading order corresponding to the constructed investment portfolio, and the communication unit 120 may transmit a trading order corresponding to the investment portfolio generated by the analysis unit 130 to the transaction server 20.

Furthermore, the storage unit 110 may store chart information for each specific type.

Additionally, the analysis unit 130 may calculate a predicted stock price for each item using chart information for each specific type, and establish a third investment strategy that reflects the calculated predicted stock price for each item.

More specifically, the analysis unit 130 may compare a stock price graph type included in the chart information for each specific type with that of a current stock price graph type of a specific stock, and may expect a future stock price graph of the specific stock as a result of the comparison.

In addition, the analysis unit 130 may establish a fourth investment strategy that reflects a predicted stock price for the specific stock using the expected future stock price graph of the specific stock.

Here, the third investment strategy may include a trading order that reflects the predicted stock price for each item.

Additionally, the fourth investment strategy may include a trading order that reflects the predicted stock price for a specific item.

Furthermore, the communication unit 120 may transmit the third investment strategy to the transaction server 20, and the communication unit 120 may transmit the fourth investment strategy to the transaction server 20.

In addition, the analysis unit 130 may select trending themes and trending items using at least one of market indicators for each market, index information, information for each item, performance information for each product, and news information and expert information converted into structured data.

Here, the analysis unit 130 may calculate a predicted stock price for each item using chart information for each specific type for the selected trending themes and trending items, and may establish a fifth investment strategy that reflects the calculated predicted stock price for each item.

Furthermore, the fifth investment strategy may include a trading order that reflects the predicted stock price for each item.

Furthermore, the communication unit 120 may transmit the fifth investment strategy to the transaction server 20.

Additionally, when the investor's transaction is concluded more than once, the fee management unit 140 may calculate a management fee for the concluded transaction using the investor's asset information.

Furthermore, the communication unit 120 may receive a contracted rate of return from the user terminal 30.

In addition, the fee management unit 140 may compare a contracted rate of return received by the communication unit 120 from the user terminal 30 and a transaction's rate of return according to a trading pattern selected by the analysis section 130.

Furthermore, the fee management unit 140 may determine whether an excess profit has been achieved by comparing the contracted rate of return and the transaction's rate of return.

In addition, as a result of the determination of the fee management unit 140, when the transaction's rate of return exceeds the contracted rate of return, the fee management unit 140 may calculate an excess profit achievement fee.

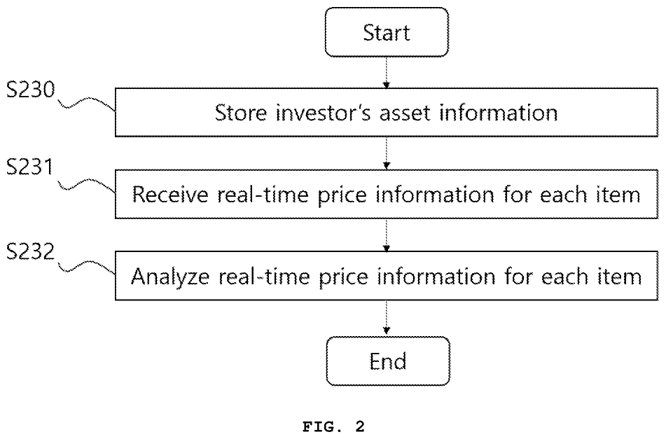

FIG. 2 is a diagram showing a schematic flow of a method of providing an automatic investment platform service, which is an embodiment of the present disclosure.

Referring to FIG. 2, the storage unit 110 may store an investor's asset information (S230).

Furthermore, the communication unit 120 may receive real-time price information for each item from the external server 10 (S231)

In addition, the analysis unit 130 may analyze real-time price information for each item (S232)

Moreover, the analysis unit 130 may calculate an appropriate price for each individual item using an analysis result of the real-time price information for each item.

Additionally, the analysis unit 130 may establish a first investment strategy based on the calculated appropriate price.

Furthermore, the communication unit 120 may transmit the first investment strategy to the transaction server 20.

Here, the first investment strategy may include a trading order that reflects an appropriate price for each individual item.

Furthermore, the communication unit 120 may receive the investor's investment propensity.

In addition, the storage unit 110 may store the investor's investment propensity received by the communication unit 120.

Moreover, the analysis unit 130 may establish a second investment strategy that reflects the investor's investment propensity.

Additionally, the communication unit 120 may transmit the second investment strategy to the transaction server 20.

Here, the second investment strategy may include a trading order that reflects an appropriate price of an item set to reflect the investor's investment propensity.

Furthermore, the storage unit 110 may store a proportion of the investor's asset.

In addition, the communication unit 120 may receive a transaction execution result according to the trading order from the external server 10.

Furthermore, when a proportion of the investor's asset changes based on the transaction execution result according to the trading order, the analysis unit 130 may establish a follow-up trading strategy so that the changed proportion of the investor's asset corresponds to that of a preset reference asset.

Additionally, the communication unit 120 may transmit a follow-up trading strategy to the trading server 20.

Here, the follow-up trading strategy may include a trading order for an item that makes the changed proportion of the investor's asset match that of the preset reference asset.

Furthermore, the storage unit 110 may store at least one of market indicators for each market, index information, information for each item, performance information for each product, news information, and expert information.

In addition, the analysis unit 130 may analyze at least one of market indicators for each market, index information, information for each item, performance information for each product, news information, and expert information to select a recommended theme.

Moreover, the communication unit 120 may transmit the recommended theme selected by the analysis unit 130 to the user terminal 30.

In addition, the storage unit 110 may store chart information for each specific type.

Furthermore, the analysis unit 130 may calculate a predicted stock price for each item using chart information for each specific type.

Furthermore, the analysis unit 130 may establish a third investment strategy that reflects the predicted stock price for each item.

Additionally, the communication unit 120 may transmit the third investment strategy to the transaction server 20.

Here, the third investment strategy may include a trading order that reflects the predicted stock price for each item.

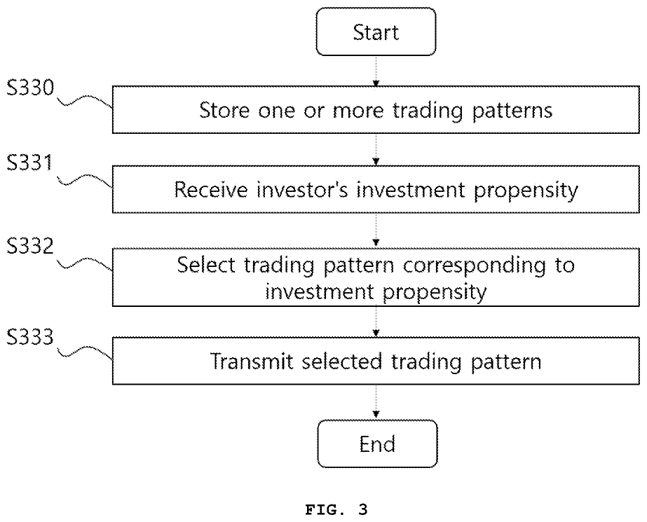

FIG. 3 is a diagram showing a schematic flow of a method of providing an automatic investment platform service, which is another embodiment of the present disclosure.

Referring to FIG. 3, the storage unit 110 may store one or more trading patterns (S330).

Furthermore, the communication unit 120 may receive the investor's investment propensity from the user terminal 30 (S331).

Additionally, the analysis unit 130 may select a trading pattern corresponding to the investor's investment propensity (S332).

Furthermore, the communication unit 120 may transmit the trading pattern selected by the analysis unit 130 to the transaction server 20 (S333).

Additionally, the communication unit 120 may receive real-time price information for each item from the external server 10.

Furthermore, the storage unit 110 may store at least one of market indicators for each market, index information, information for each item, performance information for each product, news information, and expert information.

In addition, the analysis unit 130 may construct an investment portfolio corresponding to the investor's investment propensity using at least one of real-time price information for each item and market indicators for each market, index information, information for each item, performance information for each product, news information, and the expert information.

Furthermore, the analysis unit 130 may generate a trading order corresponding to the constructed investment portfolio.

Additionally, the communication unit 120 may transmit a trading order corresponding to the investment portfolio to the transaction server 20.

Furthermore, when the investor's transaction is concluded more than once, the fee management unit 140 may calculate a management fee for the concluded transaction using the investor's asset information.

In addition, the communication unit 120 may receive a contracted rate of return from the user terminal 30.

Furthermore, the fee management unit 140 may compare the contracted rate of return and a transaction's rate of return according to the trading pattern.

In addition, the fee management unit 140 may determine whether an excess profit has been achieved when the transaction's rate of return is compared to the contracted rate of return, as a result of comparing the contracted rate of return and the transaction's rate of return according to the trading pattern.

When the transaction's rate of return exceeds the contracted rate of return, the fee management unit 140 may calculate an excess profit achievement fee.

Hereinafter, preferred embodiments of the present disclosure will be described in detail with reference to the accompanying drawings. Advantages and features of the present disclosure, and methods of accomplishing the same will be clearly understood with reference to the following embodiments described in detail in conjunction with the accompanying drawings. However, the present disclosure is not limited to those embodiments disclosed below but may be implemented in various different forms. It should be noted that the present embodiments are merely provided to make a full disclosure of the invention and also to allow those skilled in the art to know the full range of the invention, and therefore, the present disclosure is to be defined only by the scope of the appended claims. Further, like reference numerals refer to like or similar elements throughout the specification.

Unless otherwise defined, all terms (including technical and scientific terms) used in this specification may be used with meanings that can be commonly understood by those skilled in the art to which the present disclosure pertains. Additionally, terms defined in commonly used dictionaries are not interpreted ideally or excessively unless clearly specifically defined. It should be noted that the terms used herein are merely used to describe the embodiments, but not to limit the present disclosure. In this specification, unless clearly used otherwise, expressions in a singular form include a plural form.

The term “comprises” and/or “comprising” used in the specification intend to express a constituent element, a step, an operation and/or a device does not exclude the existence or addition of one or more other constituent elements, steps, operations and/or devices.

1. An automatic investment platform service providing system, the system comprising:
a storage unit that stores an investor's asset information;
a communication unit that receives real-time price information for each item from an external server; and
an analysis unit that analyzes the real-time price information for each item,
wherein the analysis unit calculates an appropriate price for each individual item using an analysis result of the real-time price information for each item, and establishes a first investment strategy based on the calculated appropriate price,
wherein the communication unit transmits the first investment strategy to a transaction server, and
wherein the first investment strategy comprises a trading order that reflects an appropriate price for each individual item.

2. The system of claim 1, wherein the analysis unit computes a relative strength based on structured data and unstructured data, including an analysis result of the real-time price information for each item, and calculates an appropriate price for the individual item using the computed relative strength.

3. The method of claim 2, wherein the structured data further comprises:
a market adjustment ratio calculated through artificial intelligence learning based on market data including at least two market indicator data, and
an item adjustment ratio calculated through artificial intelligence learning based on individual item data, including spot and/or futures price data of each individual item.

4. The method of claim 2, wherein the unstructured data comprises at least one of news information, institutional information, and expert information.

5. The system of claim 1, wherein the communication unit receives the investor's investment propensity,
wherein the storage unit stores the investor's investment propensity received by the communication unit,
wherein the analysis unit establishes a second investment strategy that reflects the investor's investment propensity,
wherein the communication unit transmits the second investment strategy to the transaction server, and
wherein the second investment strategy comprises a trading order that reflects an appropriate price of an item set to reflect the investor's investment propensity.

6. The system of claim 1, wherein the storage unit stores a proportion of the investor's asset,
wherein the communication unit receives a transaction execution result according to a trading order from an external server,
wherein when a proportion of the investor's asset changes based on the transaction execution result according to the trading order, the analysis unit establishes a follow-up trading strategy so that the changed proportion of the investor's asset corresponds to that of a preset reference asset,
wherein the communication unit transmits the follow-up trading strategy to the transaction server, and
wherein the follow-up trading strategy comprises a trading order for an item that makes the changed proportion of the investor's asset match that of the preset reference asset.

7. The system of claim 1, wherein the storage unit stores at least one of market indicators for each market, index information, information for each item, performance information for each product, news information, and expert information,
wherein the analysis unit analyzes at least one of market indicators for each market, index information, information for each item, performance information for each product, news information, and expert information to select a recommended theme, and
wherein the communication unit transmits the recommended theme selected by the analysis unit to a user terminal.

8. The system of claim 1, wherein the storage unit stores chart information for each specific type,
wherein the analysis unit calculates a predicted stock price for each item using the chart information for each specific type, and establishes a third investment strategy that reflects the predicted stock price for each item,
wherein the communication unit transmits the third investment strategy to the transaction server, and
wherein the third investment strategy comprises a trading order that reflects an predicted stock price for each item.

9. An automatic investment platform service providing method, the method comprising:
storing, by a storage unit, an investor's asset information;
receiving, by a communication unit, real-time price information for each item from an external server; and
analyzing, by an analysis unit, the real-time price information for each item,
wherein the analyzing of, by the analysis unit, the real-time price information for each item comprises:
calculating, by the analysis unit, an appropriate price for each individual item using an analysis result of the real-time price information for each item;
establishing, by the analysis unit, a first investment strategy based on the calculated appropriate price; and
transmitting, by the communication unit, the first investment strategy to a transaction server, and
wherein the first investment strategy comprises a trading order that reflects an appropriate price for each individual item.

10. The method of claim 9, wherein the analyzing of, by the analysis unit, the real-time price information for each item comprises:
receiving, by the communication unit, the investor's investment propensity;
storing, by the storage unit, the investor's investment propensity received by the communication unit;
establishing, by the analysis unit, a second investment strategy that reflects the investor's investment propensity; and
transmitting, by the communication unit, the second investment strategy to the transaction server, and
wherein the second investment strategy comprises a trading order that reflects an appropriate price of an item set to reflect the investor's investment propensity.

11. The method of claim 9, wherein the analyzing of, by the analysis unit, the real-time price information for each item comprises:
storing, by the storage unit, a proportion of the investor's asset;
receiving, by the communication unit, a transaction execution result according to a trading order from an external server;
establishing, by the analysis unit, when a proportion of the investor's asset changes based on the transaction execution result according to the trading order, a follow-up trading strategy so that the changed proportion of the investor's asset corresponds to that of a preset reference asset; and
transmitting, by the communication unit, the follow-up trading strategy to the trading server, and
wherein the follow-up trading strategy comprises a trading order for an item that makes the changed proportion of the investor's asset match that of the preset reference asset.

12. The method of claim 9, wherein the analyzing of, by the analysis unit, the real-time price information for each item comprises:
storing, by the storage unit, at least one of market indicators for each market, index information, information for each item, performance information for each product, news information, and expert information;
analyzing, by the analysis unit, at least one of market indicators for each market, index information, information for each item, performance information for each product, news information, and expert information to select a recommended theme; and
transmitting, by the communication unit, the recommended theme selected by the analysis unit to a user terminal.

13. The method of claim 9, wherein the analyzing of, by the analysis unit, the real-time price information for each item comprises:
storing, by the storage unit, chart information for each specific type;
calculating, by the analysis unit, a predicted stock price for each item using the chart information for each specific type;
establishing, by the analysis unit, a third investment strategy that reflects the predicted stock price for each item; and
transmitting, by the communication unit, the third investment strategy to the transaction server, and
wherein the third investment strategy comprises a trading order that reflects a predicted stock price for each item.
